(19) United States
(12) Patent Application Publication
(10) Pub. No.: US 2013/0206055 A1
(43) Pub. Date: Aug. 15, 2013

(54) AUTOMATIC BOOKMARK AND PAPER CLIP

(71) Applicants: EDO MORAN WEXLER, Jerusalem (IL); MICHAEL WEXLER, Jerusalem (IL)

(72) Inventors: EDO MORAN WEXLER, Jerusalem (IL); MICHAEL WEXLER, Jerusalem (IL)

(21) Appl. No.: 13/396,912

(22) Filed: Feb. 15, 2012

(51) Int. Cl. B42D 9/02

(52) U.S. Cl. 116/234

(57) ABSTRACT

A bookmark which automatically holds a reader's place in a book, which may serve also as a decorative paper clip. The bookmark is made of two flat plates, on which an elastic band is mounted. When used as an automatic bookmark, the plates are mounted on a corner of the book's last page, and the elastic band is stretched to rest diagonally over a corner of any given page of the book. The elastic band serves both to mark the page being presently read, and to press the two plates firmly against each other, tightly clenching the corner of the book's last page. When used as a paper clip, several pages are clamped between the two plates. The plates may be made of plastic sheet. They may be cut from discarded credit card, or incorporated into the plastic carrier framing SIM card.

### BACKGROUND OF THE INVENTION

1. Field of the Invention

The present invention relates to a bookmark that will automatically mark a newly opened page as the reader progressively turns the pages of a book.

A unique feature of the present invention is that its main components can be made from a standard plastic card the size of a credit card, thus offering new use for expired credit cards, membership cards, and for the leftover plastic of cards serving as the carrier from which SIM cards, mini-SIM cards, and micro-SIM cards are extracted.

The present invention may be used also as a decorative paper clip.

2. Description of the Prior Art

There are several prior inventions of automatic bookmarks. Those which bear the greatest resemblance to the present invention are listed here:

a. Ser. No. 565,818 (F. D WARD, 1896)

b. U.S. Pat. No. 1,914,001 (M. WARSHAY, 1933)

c. U.S. Pat. No. 4,778,201 (KOUNO et al, 1988)

d. WO 2010/090419 A1 (CHO, Jinwoo 2010)

Several additional patents for automatic bookmarks are listed here:

e. U.S. Pat. No. 6,015,166 (Rober M. May, 2000)

f. U.S. Pat. No. 6,082,772 (Matsumoto, 2000)

g. US 2011/0220008A1 (Kenji Kamiya, 2011)

Some paper clips patents are listed below,

h. Ser. No. 799,873 (L. SENGE, 1905)

i. U.S. Pat. No. 2,452,514 (Lech W. S. Zyehlinski et al 1946)

j. D623229 (Jerry L. Ray 2010)

Compared to the prior art, the present invention is unique in being composed of two flat plates, where elastic band serves to press the two plates against each other, providing firm grip on the page or plurality of pages which are held between the plates.

The present invention is distinguished also in combining the following features:

Low manufacturing costs, ease of use, ornamental by virtue of printing any design on Its plates, will not fall of the book, will prevent pages from being inadvertently turned by wind or by the reader dropping the book, may serve as a decorative paper clip, may be made from discarded credit cards and similar plastic cards

### SUMMARY OF THE INVENTION

The present invention of automatic bookmark and paper clip is comprised of two flat plates, pressed against each other by the stretching force of an elastic band which is woven through several slots made in each plate.

When used as an automatic bookmark, the same elastic band is stretched to rest diagonally on the corner of the presently read page. When reading of a page is completed and the page is turned, the corner of the page will just naturally withdraw from beneath the elastic band, and the band will rest on the newly exposed page.

Compared to previous inventions, this bookmark has superior gripping force on the book's page, created by the friction of the two plates pressing against the page on which they are mounted.

The plates, being essentially two dimensional, are cut from a flat sheet by a single die-cut punch operation, obviating the need for any additional machining operation.

The flat sheet may bear an artwork, printed using the low cost techniques commonly used to print credit cards and similar plastic cards.

The elastic band may be a simple rubber band, commonly used for office use. When used as a paper clip, the papers to be held together are grasped between the two flat plates.

### BRIEF DESCRIPTION OF DRAWINGS

FIG. 1 is a perspective view showing the present invention

FIG. 2 is a perspective view showing the present invention after turning it around the hypotenuse visible in the center of FIG. 1

FIG. 3 is a perspective view of the present invention used as a paper clip, with two pages clamped together.

FIG. 4 is a top view of the present invention, used as an automatic bookmark on a book.

FIG. 5 is a top view of the elastic band and the two flat plates which comprise the present invention.

FIG. 6 is a top view of a SIM card which incorporates the rear and front plates of the second embodiment of the present invention

### DETAILED DESCRIPTION OF THE INVENTION

The present invention is a bookmark which continuously and automatically marks the reader's place while reading. If the reader is interrupted or drops the book, the reader's place is marked without any additional action. Upon closing the book, the page is automatically marked.

The present invention may be used also as a decorative paper clip.

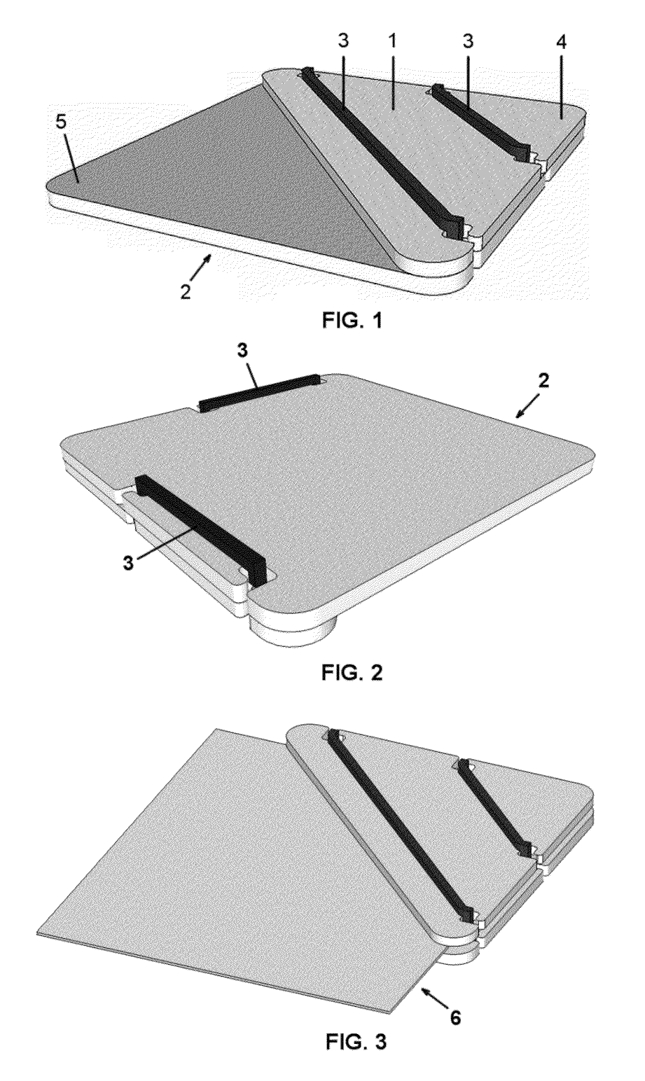

FIG. 1 shows the preferred embodiment of the present invention. It consists of a triangular front plate 1, a rectangular rear plate 2, and an elastic band 3.

FIG. 2 illustrates the path of the elastic band 3 over the back side of the bookmark

FIG. 3 shows the present invention serving as a paper clip, showing 2 pages 6 clamped between the two plates.

Placing pages between the two plates is accomplished by grasping the top-right corner 4, then pressing a corner of the stack of pages against the bottom-left corner 5 of the rear plate: this will slightly bend the rear plate away from the front plate, thus opening a gap between the two plates. The corner of the stack of papers is then inserted into this gap, such that the two plates completely overlap the corner of the stack of pages.

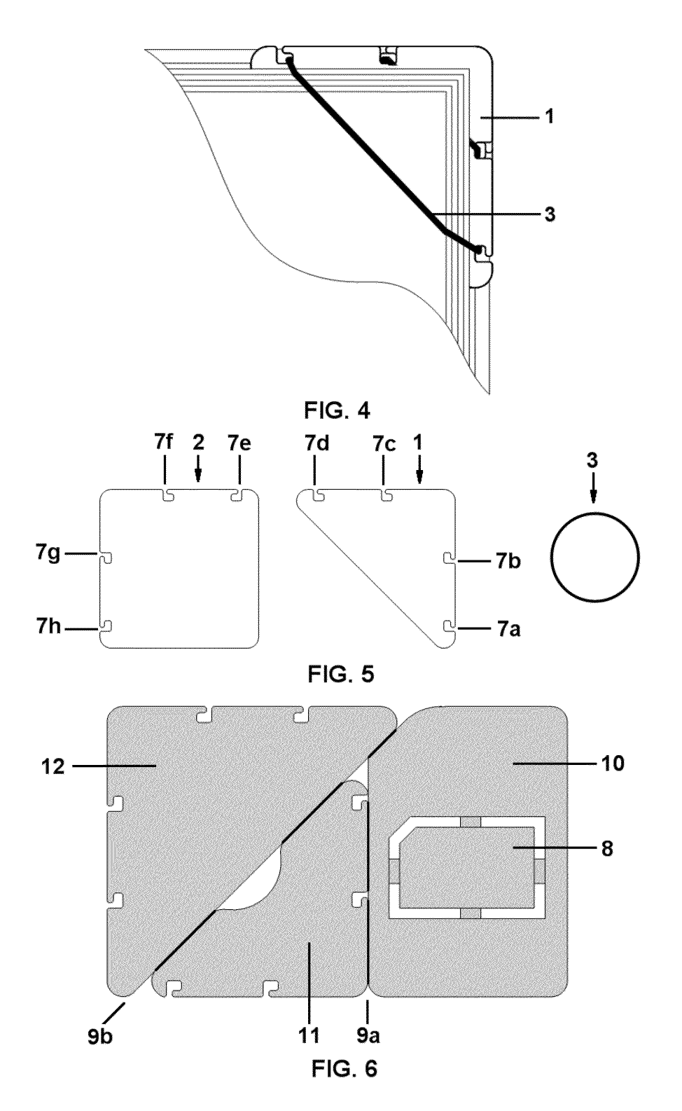

FIG. 4 shows the present invention serving as an automatic bookmark: the top right corner of the last page of the book is clamped between the front plate 1 and the rear plate 2, and the elastic band 3 is resting on the page being currently open.

Upon starting to read a book for the first time, the reader has to attach the bookmark to either the top or bottom corner of the last page of a book, and then to stretch the elastic band 3 over all the pages of the book, until it rests over the first page of the book.

Attaching the bookmark to either the top or bottom corner of the last page of a book is accomplished by grasping the top-right corner of the bookmark, then pressing the corner of the last page against the bottom-left corner of the rear plate 5: this will slightly bend the rear plate away from the front plate, thus opening a small gap between the two plates. The corner of the last page is then inserted into this gap, such that the two plates completely overlap the corner of the last page.

The reader then extends the elastic band 3 over all the pages of the book, until it rests over the first page of the book. When reading of a page is completed and the page is turned, the corner of the turned page will just naturally withdraw from beneath the elastic band, and thus the band will rest on the newly exposed page.

If the book is considerably thick, it is more reasonable to initially install the bookmark not on the last page of the book, but on a more forward page of the book.

The tension of the elastic band causes the two plates to press against each other, securely grasping the corner of the book's last page, which is held between the two plates. This keeps the bookmark from falling of the book.

The reader may opt to use the present invention as a standard, non-automatic bookmark by mounting the bookmark on the last read page, such that the last read page is grasped between the two flat plates.

The plates may be made of plastic sheet, of the same materials and thicknesses which are used to make credit cards, or of materials of similar qualities.

PVC and ABS were found to be very suitable, the appropriate thickness being 0.5 mm to 1.2 mm.

An appropriate size for the front plate is between 40 mm and 52 mm for each of its identical edges.

To facilitate easy insertion of paper into the bookmark, the rear plate should extend at least 6 mm beyond the hypotenuse of the front plate.

The elastic band 3 may be a simple rubber band, commonly used for office use.

A rubber band measuring 1.2 mm in thickness, 1.6 mm in width, having lay flat length of 44 mm has been found to be suitable for a bookmark having front plates measuring 42 mm for each of the front plate's identical edges.

Slots are made in each of the flat plates, as is best depicted in FIG. 5 (7a through 7h). The slots are shaped in such a way as to prevent the elastic band from escaping.

FIG. 6 shows the second embodiment of the present invention, with the two plates incorporated as part of the plastic carrier of a SIM (Subscriber Identity Module) card.

The shape of the front plate 11 and rear plate 12 is appropriate for integrating the two plates in the plastic which serves as the carrier for SIM card 8, mini-SIM card, or micro-SIM card, thus exploiting the otherwise leftover plastic area of the carrier.

Scoring lines 9a and 9b are grooved in the plastic. These scoring lines facilitate the user to snap apart the two plates.

The SIM 8 is affixed in the industry standard manner. Lead 10 points to the area which is leftover once the two plates and SIM are snapped apart.

1. An automatic bookmark and paper clip, for use in combination with a book or with any collection of paper pages, comprising:
a. a flat front plate, essentially isosceles right triangle in shape, made from a sheet of flexible, resilient material,
b. a flat rear plate, either isosceles right triangle or rectangular in shape, the area of said rear plate being slightly larger than said front plate, such that said rear plate extends beyond the hypotenuse of said front plate, said rear plate being made from a sheet of flexible, resilient material,
c. an elastic band,
said plates having slots through which said elastic band is woven, such that the elasticity of said band causes said plates to press against each other, whereby when said plates are mounted on either top or bottom corner of a book's last page, such that the corner of said last page is compressed between said plates, said elastic band can be stretched to rest over a corner of any given page of the book.

2. The automatic bookmark and paper clip recited in claim 1, with a plurality of elastic bands, such that one or more bands are used to press the two plates against each other, and another band serves to mark the currently read page.

3. The automatic bookmark and paper clip recited in claim 1, wherein said flat plates are cut from a plastic card, said card having the size of a standard credit card, thus exploiting expired credit cards, membership cards, and similar unused plastic cards.

4. The automatic bookmark and paper clip recited in claim 1, wherein said flat plates are cut or broken from a plastic card, said card serving as the carrier to which a SIM card, a mini-SIM card, or a micro-SIM card is affixed, by manually breaking said plates along scoring lines grooved into said plastic cards, thus exploiting most of the leftover plastic area of the carrier.
